(19) United States
(12) Patent Application Publication
(10) Pub. No.: US 2010/0223550 A1
(43) Pub. Date: Sep. 2, 2010

(54) APPRATUS, PROGRAM AND METHOD FOR ASSISTING A USER IN UNDERSTANDING CONTENT

(75) Inventors: Shinji Iizuka, Kanagawa (JP); Kohtaroh Miyamoto, Kanagawa (JP); Reiko Nagatsuma, Kanagawa (JP)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/711,683

(22) Filed: Feb. 24, 2010

(30) Foreign Application Priority Data
Feb. 27, 2009 (JP) 2009-46912

(51) Int. Cl. G06F 3/01

(52) U.S. Cl. 715/708; 715/705

(57) ABSTRACT

An assisting apparatus, method and computer program that assists a user in understanding content. The assisting apparatus includes a history storing unit that stores a history of assistance settings set up by the user for each of a plurality of pieces of content already accessed by the user, a retrieval unit that, when the user accesses content, retrieves the history of assistance settings stored in the history storing unit in association with the accessed content, and a setting-up unit that sets up one of assisting functions that assists the user in understanding the accessed content, on the basis of the history of assistance settings retrieved by the retrieval unit.

### CROSS REFERENCE TO RELATED APPLICATION

This application claims priority under 35 U.S.C. § 119 from Japanese Patent Application No. 2009-46912 filed Feb. 27, 2009, the entire contents of which are incorporated herein by reference.

### BACKGROUND OF THE INVENTION

1. Field of the Invention

The present invention relates to an apparatus, a program and a method that assists a user in understanding content.

2. Description of the related art

There exist web browsers that assist people such as the elderly and physically challenged in browsing web pages. For example, see “Easy Web Browsing V2.0 (online)” IBM Japan Ltd., retrieved on Dec. 26, 2008 (http://www-06.ibm.com/jp/accessibility/solution_offerings/EasyWebBrowsing.ht ml). Such a browser can execute assistance functions such as displaying enlarged characters, reading out characters, displaying a ruler, and displaying a particular part of a web page in a highlighted manner.

### SUMMARY OF THE INVENTION

According to an aspect of the present invention, there is provided an apparatus that assists a user in understanding content. The apparatus includes a history storing unit that stores a history of assistance settings set up by the user, a retrieval unit that retrieves the history of assistance settings, and a setting-up unit that sets up assisting functions that assists the user in understanding the accessed content.

According to another aspect of the present invention there is provided a method for assisting a user in understanding content. The method includes storing, in a history storing unit, a history of assistance settings set up by the user for each of a plurality of pieces of content already accessed by the user; in response to the user accessing content, retrieving the history of assistance settings stored in the history storing unit in association with the accessed content; and setting assisting functions that assist the user in understanding the accessed content, on the basis of the retrieved history of assistance settings.

According to yet another aspect of the present invention, there is provided a computer program product for assisting a user in understanding content. The computer program product includes a computer readable storage medium having computer readable program code embodied therewith. The computer readable program code includes computer readable program code configured to cause the computer to function as: a history storing unit that stores a history of assistance settings set up by the user for each of a plurality of pieces of content already accessed by the user; a retrieval unit that, in response to the user accessing content, retrieves the history of assistance settings stored in the history storing unit in association with the accessed content; and a setting-up unit that sets up an assisting function that assists the user in understanding the accessed content, on the basis of the history of assistance settings retrieved by the retrieval unit.

### BRIEF DESCRIPTION ON THE DRAWINGS

For a more detailed description of the present invention, reference is now made to the following description taken in conjunction with the accompanying drawings.

FIG. 1 shows a configuration of a content providing system 10 according to an embodiment of the present invention.

FIG. 2 shows a functional configuration of an assisting device 30.

FIG. 3 shows one example of a web page displayed by a providing device 28, and one example of a selection menu displayed on the web page by the assisting device 30.

FIG. 4 shows one example of a history of assistance settings set up by one user with respect to content contained in web pages.

FIG. 5 shows one example of a history of assistance settings set up by the entirety of a plurality of users with respect to content contained in web pages.

FIG. 6 shows one example of a menu inclusion reference value.

FIG. 7 shows a processing flow of the assisting device 30.

FIG. 8 shows details of processing in step S15 of FIG. 7.

FIG. 9 shows one example of a hardware configuration of a computer 1900 according to the embodiment of the present invention.

### DETAILED DESCRIPTION OF THE PREFERRED EMBODIMENTS

In browsers that can execute assistance functions, a user needs to select and set up an assistance function appropriate for the user out of many assistance functions. It is desirable that, from the beginning, a content provider provide web pages which can be easily understood by people such as the elderly or physically challenged. However, it is difficult to completely know in advance how to make a certain web page easily understandable by people such as the elderly or physically challenged. Therefore, it is difficult to create in advance web pages that can provide appropriate content.

One aspect of the present invention is an assisting apparatus that assists a user in understanding content, the assisting apparatus including: a history storing unit that stores a history of assistance settings set up by the user for each of a plurality of pieces of content already accessed by the user; a retrieval unit that, when the user accesses content, retrieves the history of assistance settings stored in the history storing unit in association with the accessed content; and a setting-up unit that sets up one of the assisting functions that assists the user in understanding the accessed content, on the basis of the history of assistance settings retrieved by the retrieval unit. Furthermore, a program and an assisting method which cause a computer to function as the assisting apparatus as described above are provided. Note that not all characteristics necessary for the present invention are listed in the above described summary of the invention. Additionally, a sub-combination of groups consisting of any one of these characteristics may be an invention.

Although the present invention will be described below by means of an embodiment of the invention, the following embodiment is not provided to limit the invention according to the scope of claims. Additionally, not all characteristics described in the embodiment are necessarily essential for solving means of the invention.

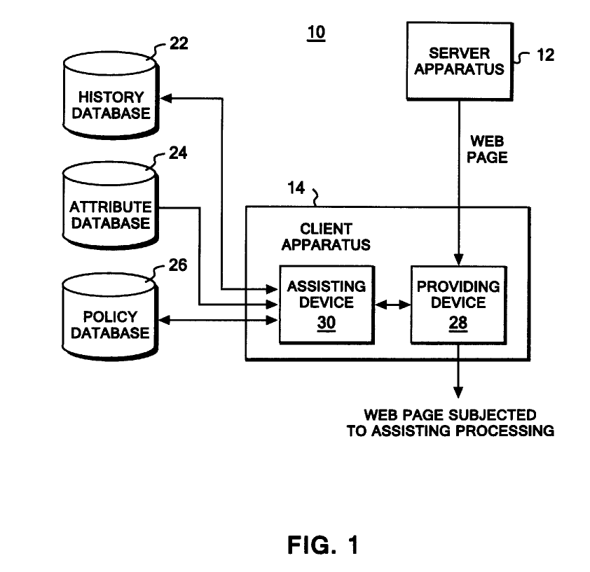

FIG. 1 shows a configuration of a content providing system 10 according to this embodiment. The content providing system 10 includes a server apparatus 12, a client apparatus 14, a history database 22, an attribute database 24 and a policy database 26. The server apparatus 12 provides web pages to the client apparatus 14 through a network, the web pages each containing one or plural pieces of content.

The client apparatus 14 is implemented by a computer that receives information from a user and provides information to the user. The client apparatus 14 includes a providing device 28 and an assisting device 30. The providing device 28 is implemented by the client apparatus 14 itself when the client apparatus 14 executes a browser program and the like. Also, the assisting device 30 is implemented by the client apparatus 14 itself when the client apparatus 14 executes an assisting program and the like.

The providing device 28 accesses the server apparatus 12, and acquires a web page to be provided by this server apparatus 12. Then, the providing device 28 provides content included in the acquired web page to the user by displaying the content on a display screen.

The assisting device 30 assists the user in understanding content. More specifically, in order that content outputted by the providing device 28 can be easily understood by the user, the assisting device 30 performs assisting processing such as processing the content, changing the content or adding information to the content.

For example, the assisting device 30 executes assistance functions such as enlarging the size of characters on a web page, enlarging character spacing and line spacing of character strings on a web page, and performing image enlargement on images, characters and the like on a web page. Additionally, for example, the assisting device 30 executes such assistance functions as reading out characters on a web page, displaying a ruler along character strings on a web page, and displaying a particular line of characters on a web page in a highlighted manner.

Additionally, the assisting device 30 executes such assistance functions as changing background colors of images and characters on a web page, displaying a summary of a text provided on a web page, and displaying an image linked to a web page. Additionally the assisting device 30 performs such assistance functions as displaying characters.

The assisting device 30 as described above can assist users in understanding content, where the users are, for example, those having poor eyesight, those having impaired color vision, and those having learning disorders. Additionally, the assisting device 30 as described above can assist users in understanding content, where the users may be those such as children, or native speakers of languages other than a language in which the content is written.

The history database 22 stores a history of assistance functions set up by each of a plurality users for each of a plurality of pieces of content contained in web pages provided by the server apparatus 12. Furthermore, the history database 22 may store a user attribute (for example, having poor eyesight, having impaired color vision, having learning disorder, age, and the like) together with the history, with the user attribute representing a kind of assistance needed by each user.

Additionally the history database 22 may store therein a history of assistance functions set up by the plurality of users as a whole for each piece of content; that is, a history of assistance functions set up by the entirety of the users. In this case, the history database 22 stores, for each piece of content, frequencies at which the respective assistance functions have been set as the history of assistance functions set up by the entirety of the users.

The attribute database 24 stores a page attribute for each of the web pages provided by the server apparatus 12 and a content attribute of each piece of content in each web page. For example, when content is composed of character strings, the attribute database 24 stores, as a content attribute, information such as whether the character strings constitute long text or short text. Additionally, for example, the attribute database 24 stores data such as the page attribute, information on the web page provided by the server apparatus 12 such as an amount of characters therein, a tendency of coloration thereof, an amount of plug-in programs therein, and an amount of table information contained therein. Some attributes as described above may be supplied by a provider of the web page.

The policy database 26 stores menu inclusion reference values for each piece of content contained in web pages provided by the server apparatus 12. The menu inclusion reference values are used as a reference for determining whether or not each of the assistance functions should be included into a selection menu. Furthermore, the policy database 26 may store a type of user operation for each piece of content contained in web pages provided by the server apparatus 12. In response to execution of the type of user operation, an instruction to output the selection menu is issued.

Note that the history database 22, the attribute database 24 and the policy database 26 may be configured to be included inside the server apparatus 12 or inside an apparatus other than the server apparatus 12. Additionally, each of the history database 22, the attribute database 24 and the policy database 26 may have a part or the entirety of a storing function thereof implemented inside the client apparatus 14.

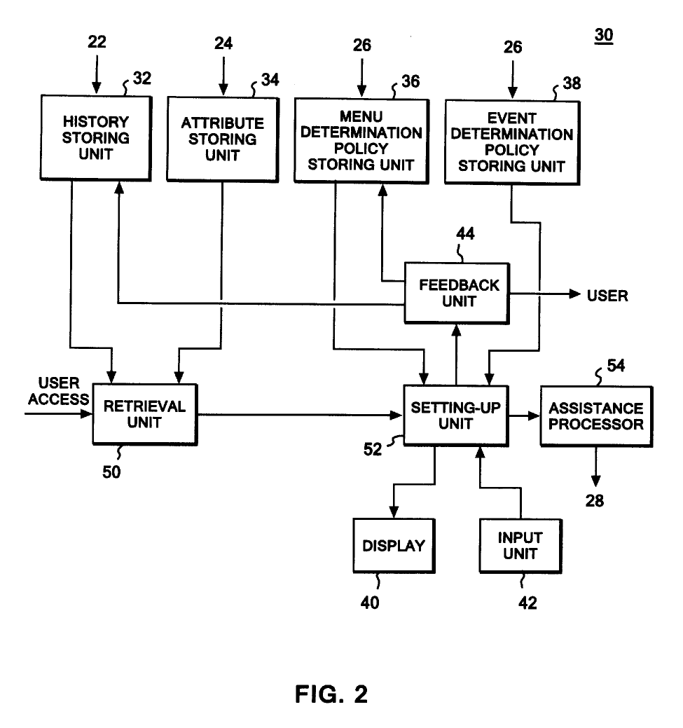

FIG. 2 shows a functional configuration of the assisting device 30. The assisting device 30 includes a history storing unit 32, an attribute storing unit 34, a menu determination policy storing unit 36, an event determination policy storing unit 38, a display 40, an input unit 42, a feedback unit 44, a retrieval unit 50, a setting-up unit 52 and an assistance processor 54.

The history storing unit 32 stores a history of assistance settings set up by a user for each of plural pieces of content already accessed by the user. For example, when a user accesses a web page, the history storing unit 32 acquires, from the history database 22, a history of assistance settings already set up by this user for each of plural pieces of content included in this web page, and stores the history.

When a user accesses a web page, for example, the history storing unit 32 may acquire, from the history database 22, a history of assistance settings set up by plural users for each of plural pieces of content included in this web page, and store the history. In this case, the history storing unit 32 may store history of assistance settings set up by the respective plural users for each piece of content in association with user attributes of the respective users.

The attribute storing unit 34 stores a content attribute for each piece of content to indicate an attribute of the corresponding content. Furthermore, the attribute storing unit 34 may store a page attribute for each web page to indicate an attribute of the corresponding web page. In a case where a user accesses a web page, for example, the attribute storing unit 34 acquires from the attribute database 24 and stores the page attribute of the web page and the content attributes of the plural pieces of content included in the web page.

The menu determination policy storing unit 36 stores a menu inclusion reference value used as a reference for determining whether or not each assistance function should be included into the selection menu. When a user accesses a web page, for example, the menu determination policy storing unit 36 acquires from the policy database 26, and stores the menu inclusion reference values of respective plural pieces of content contained in this web page.

The event determination policy storing unit 38 stores a type of user operation for each piece of content as a trigger for issuing an instruction to output the selection menu. When a user accesses a web page, for example, the event determination policy storing unit 38 acquires the types of user operations of plural pieces of content in this web page from the policy database 26, and stores the acquired types of user operations therein.

When a user accesses content on a web page, the display 40 displays the selection menu from which the user selects an assistance function which is provided to enable users to understand the content. For example, the display 40 displays the selection menu in which character strings or the like indicating assistance functions are shown in list form.

The input unit 42 inputs one assistance function selected by the user, the one assistance function being selected from plural assistance functions included in the selection menu displayed by the display 40.

The feedback unit 44 updates the menu inclusion reference value of the assistance function selected by the user from the selection menu, as a reference for determining whether or not the assistance function should be included into the selection menu. Furthermore, when a user has set up an assistance function for content, the feedback unit 44 feeds back a user attribute, if any, to the user. The user attribute fed back may indicate that a user has setup the assisting function.

When a user accesses content, the retrieval unit 50 retrieves a history of assistance setting, the history being stored in the history storing unit 32 in association with the accessed content. Then, the setting-up unit 52 sets up an assistance function on the basis of the history of assistance settings which the retrieval unit 50 has retrieved. The assistance processor 54 executes the assistance function set up by the setting-up unit 52.

When a user accesses content the retrieval unit 50 retrieves a history of assistance settings set up by the user, the history being stored in the history storing unit 32 in association with this content. Then, the setting-up unit 52 sets up an assistance function on the basis of the history of assistance settings which are set up by the user and which the retrieval unit 50 has retrieved. Then, the assisting apparatus 30 can utilize assistance setting for this content, which is set up by this user in the past, and therefore, an appropriate assistance function can be readily set.

Furthermore, when a user accesses content, the retrieval unit 50 retrieves a history of assistance settings that has been set up by a different user, the history being stored in the history storing unit 32 in association with this content. When no history of assistance settings set up by this user accessing the content is stored in the history storing unit 32 in association with this content, the retrieval unit 50 retrieves the history of assistance settings set up by the different user.

Then, the setting-up unit 52 sets up an assistance function on the basis of the history of assistance settings which were set up by different users, and which the retrieval unit 50 has retrieved. The assisting device 30 can utilize assistance setting for this content, which is set up by a plurality of different users, and an appropriate assistance function can be readily set, even if it is the first time the user accesses this content.

Furthermore, when a user accesses content, the retrieval unit 50 retrieves a history of assistance settings associated with the same user attribute as that of the user, the history being stored in the history storing unit 32. Then, the setting-up unit 52 sets up an assistance function on the basis of the history of assistance settings which is associated with the same user attribute as that of the user, and which the retrieval unit 50 has retrieved. Thereby, the assisting device 30 can utilize assistance settings set up in the past by other prior users who needed assistance that approximate assistance needed by the user. Therefore, an assistance function having a high possibility of being appropriate can be readily set even if it is the first time the user accesses the content.

Furthermore, when a user accesses content, the retrieval unit 50 retrieves a history of assistance settings set up for different content having the same content attribute as that of the accessed content. When no history of assistance settings set up for the accessed content is stored in the history storing unit 32, the retrieval unit 50 may retrieve the history of assistance settings set up for different content.

Then, the setting-up unit 52 sets up an assistance function on the basis of the history of assistance settings which are set up for the different content, and which the retrieval unit 50 has retrieved. Thereby, the assisting device 30 can utilize assistance settings set up for the approximate content which was set up by the user in the past. Therefore, an assistance function having a high possibility of being appropriate can be readily set, even if it is the first time the user accesses this content.

Additionally, in this embodiment, the setting-up unit 52 selects at least one assistance function based on a history of assistance setting which the retrieval unit 50 has retrieved, and displays the selection menu including at least one assistance function thus selected. For example, the setting-up unit 52 includes, into the selection menu, at least one assistance function selected in descending order of frequency or percentage of having been set up in the history of assistance settings which the retrieval unit 50 has retrieved.

Even when a large number of assistance functions are retrieved by the retrieval unit 50, the assisting device 30 can display the selection menu in which an assistance function having a higher possibility of being appropriate for this user is arranged in a higher position (for example, at the top). Accordingly, the assisting device 30 can enable the user to readily select an assistance function desired by the user.

Additionally, the setting-up unit 52 may set up an assistance function whose frequency or percentage of having been set up in the history of assistance settings retrieved by the retrieval unit 50 is not less than its own reference value. The setting up unit may also select at least one assistance function in descending order of frequency or percentage of having been set up in the history, from among the assistance functions whose frequencies or percentages of having been set up are less than their respective reference values, and include the assistance function thus selected into the selection menu. The setting-up unit 52 may include, into the selection menu, an assistance function whose frequency or percentage of having been set up in the history of assistance settings retrieved by the retrieval unit 50 is not less than the menu inclusion reference value.

The assisting device 30 can include, into the selection menu, only the assistance function whose value is not less than a certain given reference values, and therefore can exclude, from the selection menu, an assistance function having a low possibility of being selected by the user. Accordingly, the assisting device 30 can have a more appropriate and simpler selection menu displayed.

Additionally, in this embodiment, when a type of user operation stored in the event determination policy storing unit 38 is performed on the accessed content, in response to this operation, the setting-up unit 52 outputs the selection menu to a user. When an operation in which the same character string is selected is repeated a predetermined number of times, the setting-up unit 52 determines that assistance in reading this character string is needed, and displays the selection menu for this character string. The assisting device 30 can have the selection menu displayed at the right time for the user.

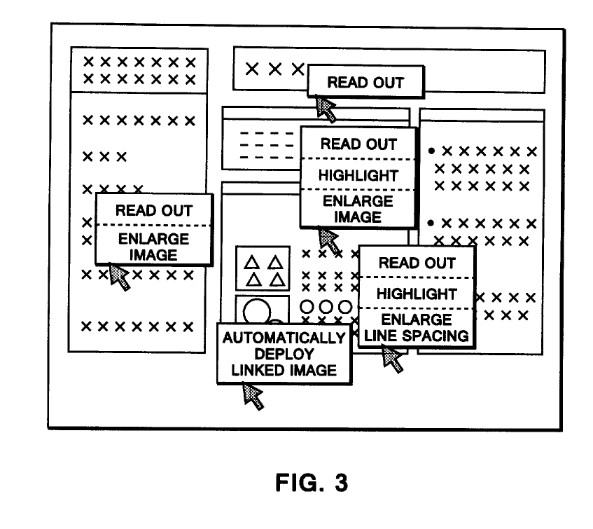

FIG. 3 shows one example of a web page displayed by the providing device 28, and one example of the selection menu displayed on this web page by the assisting device 30. When a type of user operation stored in the event determination policy storing unit 38 is performed on each piece of content displayed on the web page, a selection menu is displayed in a position corresponding to each piece of the content of the web page. Thereby, from a plurality of assistance functions included in the displayed selection menu, the user can select one assistance function needed.

Note that, although many selection menus are displayed in FIG. 3, the assisting device 30 is configured to have one selection menu displayed at once in this embodiment. Additionally, when only one assistance function is included in the selection menu the setting-up unit 52 may automatically set up the assistance function without waiting for the user to select the assistance function. Thereby, the assisting device 30 can further simplify operations performed by the user.

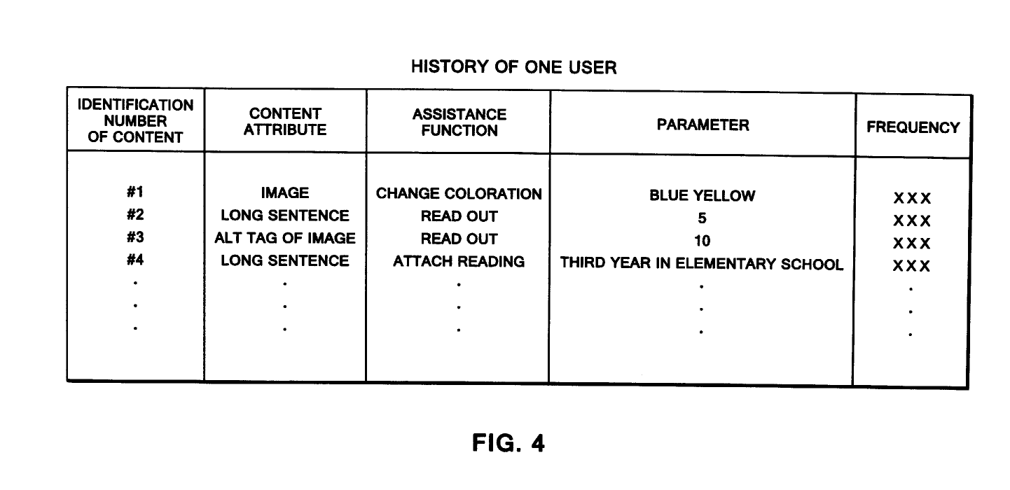

FIG. 4 shows one example of a history of assistance settings set up by one user for content contained in web pages. For example, the history storing unit 32 stores a table as shown in FIG. 4 as the history of assistance settings set up by this user for content.

This table stores a plurality of records each including an identification number of the content, a content attribute of the content, an assistance function set for the content, the parameters used for executing the assistance function, and frequency at which the assistance function have been set up. The parameters represent: a color required to be changed, when the assistance function corresponding to the parameter is to change coloration; a reading speed when the assistance function corresponding to the parameter is to read out text.

The history storing unit 32 stores a table with respect to each user. When a user accesses content, the retrieval unit 50 can retrieve a history of assistance settings set up by this user, and also a history of assistance settings set up by users other than this user by referring to the table stored in the history storing unit 32.

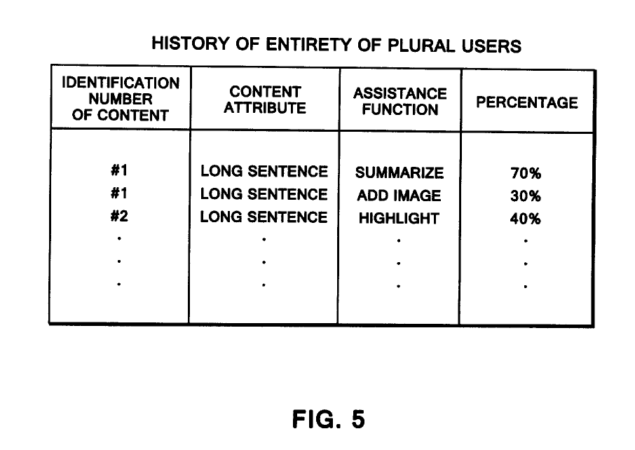

FIG. 5 shows one example of a history of assistance settings set up by the entirety of plural users for content included in web pages. For example, the history storing unit 32 stores a table as shown in FIG. 5 as the history of assistance settings set up by the plural users for content.

This table stores plural records, each including an identification number of the content, a content attribute of the content, an assistance function set up for the content, and a percentage. The percentage represents a ratio of a frequency at which the assistance function have been set up for the content by users with respect to a total frequency at which all the assistance functions have been set up for the content by the users. When a user accesses content, the retrieval unit 50 can retrieve histories of assistance settings set up by this user and by the other users by referring to the table stored in the history storing unit 32.

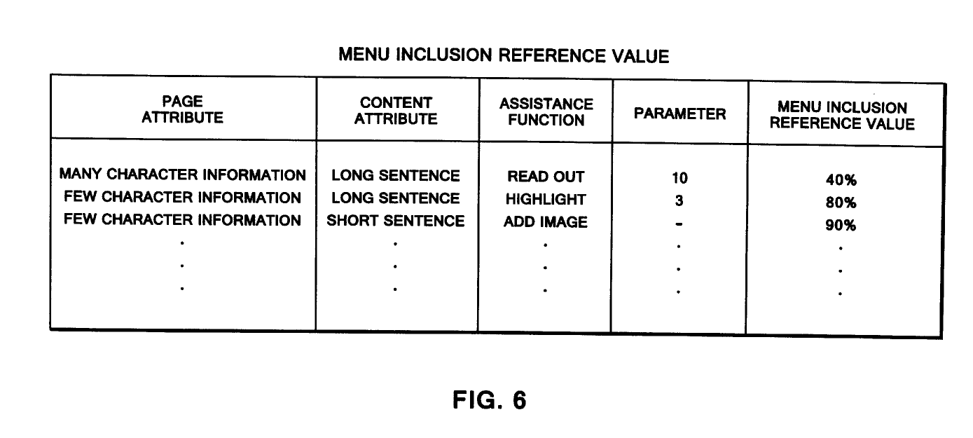

FIG. 6 shows one example of menu inclusion reference values. For example, the menu determination policy storing unit 36 stores a menu inclusion reference value for each of combinations of a page attribute, a content attribute, an assistance function and a parameter.

Each of the menu inclusion reference values represents a threshold value of frequency or percentage used for determining whether an assistance function retrieved by the retrieval unit 50 should be included into the selection menu. When a user accesses content, the retrieval unit 50 can determine whether each assistance function retrieved by the retrieval unit 50 should be included into the selection menu by referring to the menu inclusion reference value stored in the menu determination policy storing unit 36.

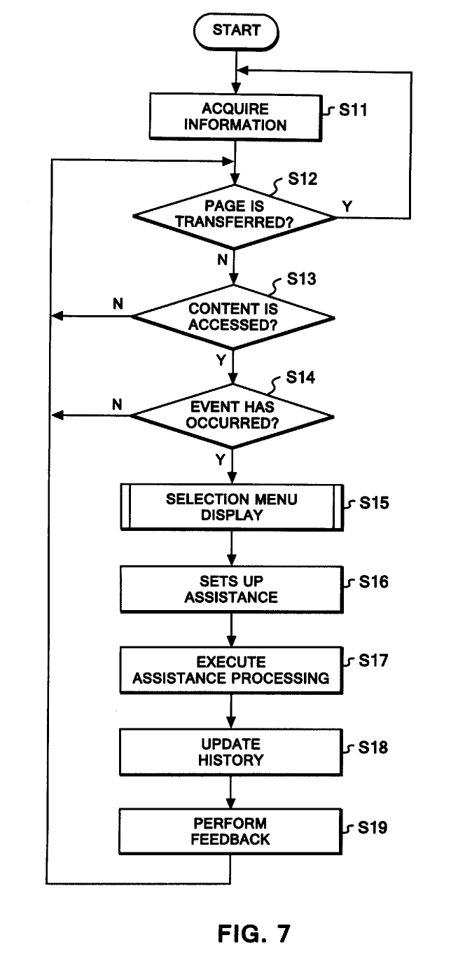

FIG. 7 shows a processing flow of the assisting device 30. The assisting device 30 starts processing from step S11 when the providing device 28 acquires a web page.

In step S11, the assisting device 30 acquires information on this web page from the history database 22, the attribute database 24 and the policy database 26. The assisting device 30 acquires a page attribute indicating an attribute of this web page; a history of assistance setting; content attributes; menu inclusion reference values with respect to respective pieces of content contained in this web page; and a type of user operation as a trigger for issuing an instruction to output the selection menu. Then, the assisting device 30 stores these pieces of information in the history storing unit 32, the attribute storing unit 34, the menu determination policy storing unit 36 and the event determination policy storing unit 38.

Then, the setting-up unit 52 of the assisting device 30 determines whether a transition from the page has been made (S12) and whether a user has accessed any of the content (S13). If a transition from the page has been made (Yes in S12), the setting-up unit 52 returns the processing to step S11. If a user has accessed any of the content (Yes in S13), the setting-up unit 52 advances the processing to step S14.

Subsequently, in step S14, the setting-up unit 52 determines whether any event has occurred with respect to the content accessed by the user. More specifically, if a type of user operation stored in the event determination policy storing unit 38 has been performed on the content accessed by the user, the setting-up unit 52 determines that an event has occurred. If no event has occurred (No in S14), the setting-up unit 52 returns the processing to step S12. If any event has occurred (Yes in S14), the setting-up unit 52 advances the processing to step S15.

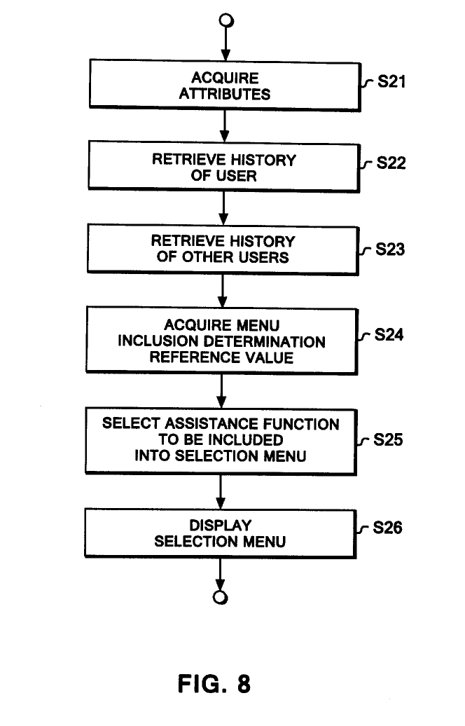

Subsequently, in step S15, the setting-up unit 52 displays the selection menu including at least one assistance function for the content accessed by the user. Details of processing for displaying the selection menu will be described with reference to FIG. 8 described later.

Subsequently, in step S16, in response to selection of the assistance function which is made by the user by using the selection menu, the setting-up unit 52 sets up the selected assistance function. Note that, when only one assistance function is included in the selection menu, the setting-up unit 52 may advance the processing to step S17 without waiting for the selection menu to be displayed in step S15 and for the user to select the assistance function in step S16.

Subsequently, in step S17, the assistance processor 54 executes the assistance function set up by the setting-up unit 52 with respect to the content accessed by the user. Subsequently, in step S18, the setting-up unit 52 updates the history of assistance setting. The setting-up unit 52 updates, for example, tables as those shown in FIGS. 4 and 5.

Subsequently, in step S19, in accordance with the assistance function set up, the feedback unit 44 changes a menu inclusion reference value of each of the assistance functions which is displayed in the selection menu in correspondence with the content accessed by the user. The feedback unit 44 changes the menu inclusion reference values so that an assistance function having been more frequently selected may have a higher chance of being included into a selection menu, and so that an assistance function having been more scarcely selected may have a lower chance of being included into a selection menu. Thereby, the feedback unit 44 can more appropriately set up an assistance function included into the selection menu.

FIG. 8 shows details of processing in step S15 of FIG. 7. The assisting device 30 executes the following processing from step S21 to step S26 in the step S15 of FIG. 7.

In step S21, the setting-up unit 52 acquires a user attribute, a content attribute, and a page attribute of the content accessed by the user. Subsequently, in step S22, the retrieval unit 50 retrieves a history of assistance settings set up for the content by the user, and extracts an assistance function set up by the user for the content in the past.

Subsequently, in step S23, the retrieval unit 50 retrieves a history of assistance settings set up for this content by users other than this user, and extract an assistance function set up by those other users for the content in the past. Note that, for example, when no history of assistance settings set up by the user is stored in the history storing unit 32, the retrieval unit 50 may retrieve the history of assistance settings set up by the other users.

Alternatively, in step S23, the retrieval unit 50 may retrieve a history of assistance settings set up by the entirety of plural users including this user and the other users, and extract an assistance function set up by all of the plural users in the past. As another alternative, in step S23, the retrieval unit 50 may retrieve a history of assistance settings of other users who are associated with the same user attribute as that of this user, and extract an assistance function that has been used in the past.

Note that, in steps S22 and S23, the retrieval unit 50 may retrieve a history of assistance settings set up for another piece of content having the same content attribute as this piece of content, and extract the history of assistance settings set up by this user or by other users. For example, when no history of assistance settings set up for the accessed content is stored in the history storing unit 32, the retrieval unit 50 may retrieve the history of assistance settings set up for another piece of content.

Subsequently, in step S24, the setting-up unit 52 acquires a menu inclusion determination reference value of each of the assistance functions extracted by the retrieval unit 50. For example, menu inclusion determination reference values which correspond to a combination of page attributes of the web page, content attributes of content and the assistance function are acquired from the menu determination policy storing unit 36.

Subsequently, in step S25, the setting-up unit 52 selects an assistance function to be included into the selection menu from the one or plural assistance functions extracted by the retrieval unit 50. The setting-up unit 52 selects, as the assistance function to be included into the selection menu, an assistance function whose frequency or percentage is larger than a menu inclusion determination reference value corresponding thereto from the assistance functions extracted by the retrieval unit 50.

In step S26, the setting-up unit 52 displays the selection menu including the selected assistance functions in a position corresponding to this content. In this case, the setting-up unit 52 displays the assistance functions to be included into the selection menu in a manner arranged from the uppermost position in a menu screen in descending order of frequency or percentage of having been selected in the past.

As has been described above, according to the assisting device 30, when a user accesses content on a web page, the user can select an assistance appropriate for the user by a simple operation.

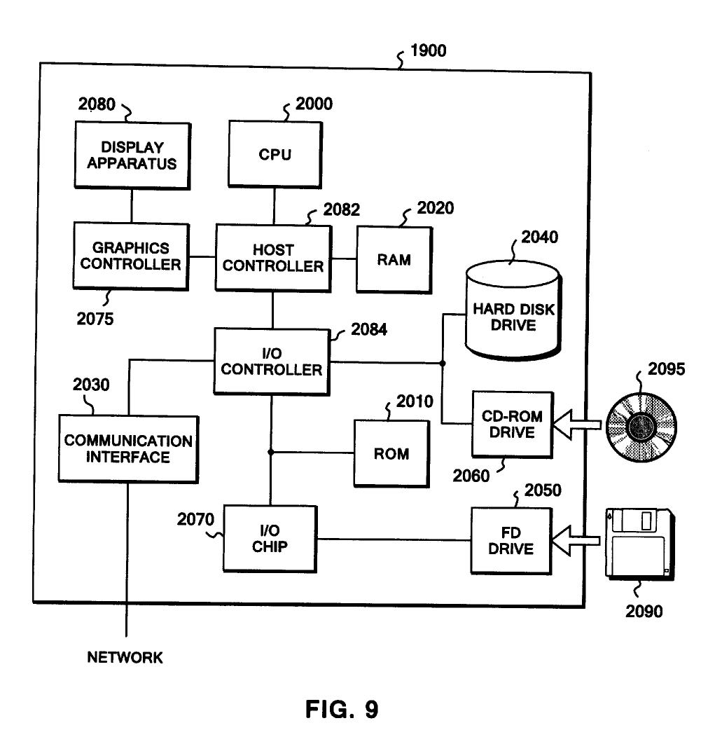

FIG. 9 is a diagram showing one example of a hardware configuration of a computer 1900 according to this embodiment. The computer 1900 according to this embodiment includes: a CPU peripheral section including a CPU 2000, a RAM 2020, a graphics controller 2075 and a display apparatus 2080 which are mutually connected by a host controller 2082; an input/output section including a communication interface 2030, a hard disk drive 2040 and a CD-ROM drive 2060 which are connected to the host controller 2082 through an input/output controller 2084; and a legacy input/output section including a ROM 2010, a flexible disk drive 2050 and an input/output chip 2070 which are connected to the input/output controller 2084.

The host controller 2082 connects the RAM 2020 to the CPU 2000 and the graphics controller 2075 which access the RAM 2020 at a high transfer rate. The CPU 2000 operates according to a program stored in the ROM 2010 and the RAM 2020, thereby controlling each unit. The graphics controller 2075 obtains image data generated by the CPU 2000 or the like on a frame buffer provided in the RAM 2020, and causes the image data to be displayed on the display apparatus 2080. Alternatively, the graphics controller 2075 may contain therein a frame buffer in which image data generated by the CPU 2000 or the like is stored.

The input/output controller 2084 connects the host controller 2082 to the communication interface 2030, the hard disk drive 2040, and the CD-ROM drive 2060 which are relatively high-speed input/output devices. The communication interface 2030 communicates with other devices through a network. The hard disk drive 2040 stores a program and data used by the CPU 2000 in the computer 1900. The CD-ROM drive 2060 reads a program or data from the CD-ROM 2095, and provides the program or the data to the hard disk drive 2040 through the RAM 2020.

Additionally, the ROM 2010, the flexible disk drive 2050 and the input/output chip 2070 which are relatively low-speed input/output devices are connected to the input/output controller 2084. The ROM 2010 stores at least any one of a boot program executed by the computer 1900 at the time of activation, a program depending on the hardware of the computer 1900, and the like. The flexible disk drive 2050 reads a program or data from a flexible disk 2090, and provides the program or the data to the hard disk drive 2040 through the RAM 2020. The input/output chip 2070 connects the flexible disk drive 2050 to the input/output controller 2084, and also connects various input/output devices to the input/output controller 2084 through, for example, a parallel port, a serial port, a keyboard port, a mouse port and the like.

A program provided to the hard disk drive 2040 through the RAM 2020 is provided by a user in a manner being stored in a recording medium such as the flexible disk 2090, the CD-ROM 2095 or an IC card. The program is read from the recording medium, installed into the hard disk drive 2040 in the computer 1900 through the RAM 2020, and executed in the CPU 2000.

A program installed into the computer 1900 to cause the computer 1900 to function as the assisting device 30 includes a history storing module, an attribute storing module, a menu determination policy storing module, an event determination policy storing module, a display module, an input module, a feedback module, a retrieving module, a setting-up module and an assisting processing module. By acting on the CPU 2000 and the like, this program or these respective modules cause the computer 1900 to function as the history storing unit 32, the attribute storing unit 34, the menu determination policy storing unit 36, the event determination policy storing unit 38, the display 40, the input unit 42, the feedback unit 44, the retrieval unit 50, the setting-up unit 52 and the assistance processor 54.

By being read into the computer 1900, information processing written in this program functions as the history storing unit 32, the attribute storing unit 34, the menu determination policy storing unit 36, the event determination policy storing unit 38, the display 40, the input unit 42, the feedback unit 44, the retrieval unit 50, the setting-up unit 52 and the assistance processor 54 which are specific means obtained through cooperation provided by software and the above described various hardware resources. These specific means are implemented through arithmetic operations or processing on information which corresponds to the purpose of use of the computer 1900 of this embodiment, and thereby the assisting device 30 uniquely corresponding to the purpose of use is configured.

In a case where communication is performed between the computer 1900 and an external apparatus or the like, the CPU 2000 executes a communication program loaded onto the RAM 2020, and based on processing content written in the communication program, instructs the communication interface 2030 to perform communication processing. By being controlled by the CPU 2000, the communication interface 2030: reads out data to be transmitted (hereinafter, transmission data) that is stored in a transmission buffer region or the like provided in any one of the storage devices such as the RAM 2020, the hard disk drive 2040, the flexible disk 2090 and the CD-ROM 2095; transmits the transmission data to a network; and writes reception data received from a network into a reception buffer or the like provided on the storage device. As described, the communication interface 2030 may transfer transmission data and reception data between itself and the storage device by a DMA (direct memory access) scheme. Alternatively, the CPU 2000 may transfer transmission data and reception data by reading the data from the storage device or the communication interface 2030, which is a source of the transfer, and then writing the data into the communication interface 2030 or the storage device, which is a destination of the transfer.

Additionally, the CPU 2000 loads all or any necessary part of files, databases and the like, which are stored in external storage devices, into the RAM 2020 through DMA transfer and the like. The CPU 2000 then performs various kinds of processing on data in the RAM 2020, the external storage devices including the hard disk drive 2040, the CD-ROM drive 2060 (CD-ROM 2095), the flexible disk drive 2050 (flexible disk 2090), and the like. Then, the CPU 2000 writes the data on which the processing has been performed back into the external storage devices through DMA transfer or the like. In the processing as described here, the RAM 2020, the external storage devices and the like are collectively referred to as memory, storage, a storage device or the like in this embodiment because the RAM 2020 can be considered as an component that temporarily retains content of the external storage devices. Various kinds of information such as various programs, data, tables, databases in this embodiment are stored on the storage device as described here, and are subject to information processing. Note that the CPU 2000 is also capable of retaining a part of information in the RAM 2020 on a cache memory, and writing and reading information into and from the cache memory. In such a configuration also, the cache memory take on a part of the function of the RAM 2020, and therefore, in this embodiment, unless otherwise described distinctly, it is assumed that the cache memory is included in the RAM 2020, the memory and/or the storage device.

Additionally, the CPU 2000 performs various kinds of processing on data read out from the RAM 2020, and then writes the data back to the RAM 2020. The various kinds of processing may be specified by instruction strings in programs and include various kinds of arithmetic operations, processing of information, conditional judgments, retrieval and replacement of information, and the like which have been described in this embodiment. When performing a conditional judgment, the CPU 2000 determines whether each of various variables shown in this embodiment satisfies a condition that the variable is larger, smaller, not more than, or not less than another variable or a constant. Then, if the condition holds true (or does not hold true), the CPU causes the processing to branch into a different instruction string or invokes a subroutine.

Additionally, the CPU 2000 is capable of retrieving information stored in a file, a database or the like in the storage device. For example, in a case where plural entries respectively having attribute values of a second attribute associated with attribute values of a first attribute are stored in the storage device, the CPU 2000: retrieves a certain entry from the plural entries stored in the storage device, the certain entry having an attribute value of the first attribute that agrees with a specified condition; and reads out an attribute value of the second attribute that is stored in the certain entry. Thus, the CPU 2000 is capable of acquiring an attribute value of the second attribute, the attribute value being associated with the first attribute that satisfies a predetermined condition.

Each of the above described program or modules may be stored in an external recording medium. As the recording medium, any one of an optical recording medium such as a DVD and a CD, a magneto-optical recording medium such as an MO, a tape medium, and a semiconductor memory such as an IC card can be used in addition to the flexible disk 2090 and the CD-ROM 2095. In addition, the program may be provided to the computer 1900 through a network from a memory device provided in a server system connected to the network. The network may be a dedicated communication network or the Internet, while the memory may be a hard disk, a RAM, or the like, and used as a recording medium.

While the present invention has been described hereinabove by means of the embodiment, the technical scope of the present invention is not limited to the extent described in the abovementioned embodiment. It will be apparent to those skilled in the art that various modifications and improvements can be added to the abovementioned embodiment. From the description of the scope of claims, it is apparent that the technical scope of the present invention should include embodiments incorporating such modifications or improvements.

It should be noted that the orders in which processes such as operations, procedure, steps and stages are executed in the apparatuses, systems, programs and methods shown in the scope of claims, the description and the drawings are not clearly specified particularly by use of expressions such as “before” and “prior to”, and that those processes can be executed in arbitrary orders unless an output from one of the processes should be used in any of the processes subsequent thereto. Even if description has been given of any operational flows in the scope of claims, the description and the drawings by use of expressions such as “firstly,” and “subsequently,” for the sake of convenience, it does not necessarily mean that it is imperative for the operational flows to be executed by the orders indicated by these expressions.

Although the preferred embodiment of the present invention has been described in detail, it should be understood that various changes, substitutions and alternations can be made therein without departing from spirit and scope of the inventions as defined by the appended claims.

We claim:

1. An apparatus that assists a user in understanding content, the apparatus comprising:
a history storing unit that stores a history of assistance settings set up by the user for each of a plurality of pieces of content accessed by the user;
a retrieval unit that retrieves, from the history storing unit, the history of assistance settings associated with the accessed content; and
a setting-up unit that sets up an assistance function that assists the user in understanding the accessed content, on the basis of the history of assistance settings retrieved by the retrieval unit.

2. The apparatus according to claim 1, wherein, in response to the history storing unit not containing any history of assistance settings set up by a first user, the setting-up unit sets up one of the assistance functions on the basis of a history of assistance setting set up by a second user.

3. The apparatus according to claim 1, further comprising an attribute storing unit that stores a content attribute for each piece of content, the content attribute indicating an attribute of the content, wherein:
in response to a user accessesing a first content, the retrieval unit retrieves the history of assistance settings set up for a second content having the same content attribute as the first content; and
the setting-up unit sets up the assisting function on the basis of the history of assistance settings set up for the second content and retrieved by the retrieval unit.

4. The apparatus according to claim 3, wherein in response to the history storing unit storing no history of assistance settings set up for the first content, the setting-up unit sets up an assistance function on the basis of the history of assistance settings set up for the second content.

5. The apparatus according to claim 4, wherein, on the basis of the history of assistance settings retrieved by the retrieval unit, the setting-up unit selects at least one assistance function for inclusion in a selection menu for selecting the assistance function.

6. The apparatus according to claim 5, wherein the setting-up unit selects at least one of the assistance functions in descending order of frequency used and includes the assistance function thus selected into the selection menu.

7. The apparatus according to claim 5, wherein the setting-up unit selects at least one of the assistance functions in descending order of percentage of having been set up in the history of assistance settings retrieved by the retrieval unit, and includes the assistance function thus selected into the selection menu.

8. The apparatus according to claim 7, wherein, in the history of assistance settings retrieved by the retrieval unit, the setting-up unit is configured to execute a method, the method comprising:
responsive to any one of the assistance functions having a frequency not less than a reference value, setting the assistance function;
responsive to any one of the assistance functions having a set up frequency percentage not less than a reference value, setting the assistance function;
selecting at least one assistance function from among the assistance functions whose frequencies are not less than a reference value; and
including the at least one selected assistance function in the selection menu.

9. The apparatus according to claim 8, further comprising:
a menu determination policy storing unit that stores a menu inclusion reference value for each piece of content, the menu inclusion reference value serving as a reference for determining whether each assistance function should be included into the selection menu, wherein the setting-up unit further comprises:
any one of the assistance functions whose frequency of having been set up in the history of assistance settings retrieved by the retrieval unit is not less than the menu inclusion reference value; and
any one of the assistance functions whose percentage of having been set up in the history of assistance settings retrieved by the retrieval unit is not less than the menu inclusion reference value.

10. The apparatus according to claim 9, further comprising:
an event determination policy storing unit that stores, for each piece of content, a type of user operation as a trigger for issuing an instruction to output the selection menu, wherein in response to an event in which the accessed content is operated by the type of user operation stored for the accessed content in the event determination policy storing unit, the setting-up unit outputs the selection menu for accessed content to the user.

11. The apparatus according to claim 10, wherein:
the history storing unit stores, in association with a user attribute of each of a plurality of users, a history of assistance settings set up by each user for each piece of content; and
in response to a user accessing content, the setting-up unit retrieves the history of assistance settings associated with the same user attribute as that of the user.

12. The apparatus according to claim 11, further comprising:
a feed back unit, wherein:
the setting-up unit sets up one of the assistance functions selected by the user from the selection menu; and
under the condition that the percentage of users who have set up the assisting function for content is not less than a reference value, the feed back unit feeds the corresponding user attribute to the user.

13. The apparatus according to claim 1, the apparatus further comprising:
an event determination policy storing unit that stores, for each piece of content, a type of user operation as a trigger for issuing an instruction to output a selection menu.

14. A method for assisting a user in understanding content, the method comprising:
storing, in a history storing unit, a history of assistance settings set up by the user for each of a plurality of pieces of content already accessed by the user;
in response to the user accessing content, retrieving the history of assistance settings stored in the history storing unit in association with the accessed content; and
setting up one of assisting functions that assists the user in understanding the accessed content, on the basis of the retrieved history of assistance settings.

15. A computer program product for assisting a user in understanding content, the computer program product comprising:
a computer readable storage medium having computer readable program code embodied therewith, the computer readable program code comprising computer readable program code configured to cause the computer to function as:
a history storing unit that stores a history of assistance settings set up by the user for each of a plurality of pieces of content already accessed by the user;
a retrieval unit that, in response to the user accessing content, retrieves the history of assistance settings stored in the history storing unit in association with the accessed content; and
a setting-up unit that sets up one of assisting functions that assists the user in understanding the accessed content, on the basis of the history of assistance settings retrieved by the retrieval unit.
